(19) United States
(12) Patent Application Publication
(10) Pub. No.: US 2026/0250118 A1
(43) Pub. Date: Aug. 27, 2026

(54) SYSTEM AND METHOD FOR DISPENSING A CONSUMABLE MATERIAL

(71) Applicant: Breville Pty Limited, Alexandria, New South Wales (AU)

(72) Inventors: Lochana Subasekara WIDANAGAMAGE DON, Alexandria, New South Wales (AU); Con PSAROLOGOS, Alexandria, New South Wales (AU); Xiang REN, Alexandria, New South Wales (AU)

(73) Assignee: Breville Pty Limited, Alexandria, New South Wales (AU)

(21) Appl. No.: 18/878,142

(22) PCT Filed: Jun. 29, 2023
(86) PCT No.: PCT/AU2023/050597

§ 371 Date: Dec. 23, 2024

(30) Foreign Application Priority Data
Jun. 30, 2022 (AU) 2022901852

(51) Int. Cl. B67D 1/12; B67D 1/08

(52) U.S. Cl. CPC B67D 1/1236; B67D 1/0888; B67D 1/1238

(57) ABSTRACT

A system for dispensing a consumable material, the system comprising a dispenser to dispense the consumable material into a receptacle, a receptacle sensor configured to emit a signal and receive a reflected signal from the receptacle, the receptacle sensor being movable relative to the receptacle, a motor operatively connected to the receptacle sensor to move the receptacle sensor relative to the receptacle, and a controller configured to determine a physical parameter of the receptacle based on the reflected signal and an operational parameter of the motor, wherein the dispenser dispenses the consumable material into the receptacle based on the physical parameter.

### FIELD

The present invention relates to a system and method for dispensing a consumable material. In particular, the invention relates to systems installed in kitchen devices, and use thereof, for dispensing a beverage or other consumable food material.

### BACKGROUND

Beverage or other consumable material dispensing devices such as coffee machines, water dispensers etc. are often used to dispense a beverage into a cup. As cups can vary substantially in their size and shape, such dispensing devices are unable to ascertain an appropriate quantity of the beverage to be dispensed. For example, when a small piccolo cup is being used, a coffee machine may be unable to detect a size of the cup and dispense too much coffee such that it overflows from the cup. It is also not possible for such dispensing devices to dispense a preferred volumetric quantity of the beverage relative to the size of the cup (for example, one cup, half cup etc.) without the user having to input the exact volume of the beverage to be dispensed.

Moreover, the dispensing devices are unable to detect if the cup has been incorrectly placed under the dispenser or a center position of the cup. Even if it is detected that the cup is incorrectly placed or slightly offset, the dispensing devices would be unable to dispense the beverage without the cup being relocated to the correct position.

### SUMMARY

It is an object of the present invention to substantially overcome, or at least ameliorate, one or more of the disadvantages of existing arrangements, or at least provide a useful alternative to existing arrangements.

In a first aspect, although not necessarily the only or broadest form, the invention resides in a system for dispensing a consumable material, the system comprising:
a dispenser to dispense the consumable material into a receptacle;
a receptacle sensor configured to emit a signal and receive a reflected signal from the receptacle, the receptacle sensor being movable relative to the receptacle;
a motor operatively connected to the receptacle sensor to move the receptacle sensor relative to the receptacle;
a controller configured to determine a physical parameter of the receptacle based on the reflected signal and an operational parameter of the motor;
wherein the dispenser dispenses the consumable material into the receptacle based on the physical parameter.

Preferably, the consumable material is a beverage. Preferably, the system is incorporated in a coffee machine.

Preferably, the dispenser comprises an outlet to dispenser the consumable material. Preferably, the dispenser comprises a sensor to determine a level of the dispensed consumable material in the receptacle. Preferably, the sensor comprises an infrared, ultrasonic, time-of-flight or LIDAR sensor. Preferably, the dispenser dispenses a quantity of the consumable material into the receptacle based on the level of the dispensed consumable material in the receptacle.

Preferably, the receptacle sensor moves along a shaft connected to the motor.

Preferably, the shaft is a lead screw or a linear actuator. Preferably, rotational movement of the motor is converted to linear movement by the shaft to move the receptacle sensor along the shaft. Preferably, the receptacle sensor comprises a housing that is connected to the shaft.

Preferably, the receptacle sensor comprises a transmitter configured to emit a signal and a receiver configured to receive the reflected signal, wherein the signal is reflected from a wall of the receptacle. Preferably, the receptacle sensor comprises an infrared, ultrasonic, time-of-flight or LIDAR sensor.

Preferably, the motor is a stepper motor, DC motor, AC motor or Brushless DC motor. Preferably, the motor is connected to a sensor configured to determine the operational parameter of the motor. Preferably, the motor is connected to a Hall sensor. Preferably, the operational parameter of the motor is a number of the revolutions or steps of the motor. Preferably, the operational parameter of the motor is used to calculate displacement of the receptacle sensor along the shaft.

Preferably, the receptacle is placed on a receptacle base. Preferably, the receptacle base is a drip tray. Preferably, the receptacle base comprises a weight sensor to sense the receptacle.

Preferably, the receptacle sensor senses the receptacle by emitting a signal from the transmitter and receiving the reflected signal by the receiver, the signal being reflected from a wall of the receptacle. Preferably, the controller compares the reflected signal received by the receiver with a previous reflected signal to determine a change in signal intensity. Preferably, the controller determines that the receptacle sensor has moved beyond an edge of the receptacle when the change in signal intensity is detected. Preferably, when the change in signal intensity is detected, the controller determines the displacement of the receptacle sensor along the shaft to be a height of the receptacle. Preferably, the physical parameter of the receptacle is the height of the receptacle.

Preferably, the dispenser dispenses the consumable material into the receptacle based on a user preference. Preferably, the user preference includes a quantity of the consumable material to be dispensed. Preferably, a quantity of the consumable material dispensed by the dispenser is based on the physical parameter of the receptacle. Preferably, the dispenser dispenses a quantity of the consumable material into the receptacle based on the level of the dispensed consumable material in the receptacle.

Preferably, the system further includes an anti-condensation module configured to prevent condensation from being formed on the receptacle sensor. Preferably, the anti-condensation module comprises an outlet through which air is blown or sucked. Preferably, an anti-condensation coating is applied to a lens of the receptacle sensor and/or the sensor of the dispenser.

Preferably, the receptacle sensor and the dispenser are located in a sensor carriage that is movable relative to the receptacle.

Preferably, the controller determines a reflective value of the reflected signal. Preferably, a distance from the surface from which the signal is reflected is calculated based on the reflective value. Preferably, when a change in the distance is detected, the controller records the distance. Preferably, the physical parameter of the receptacle is calculated based on the recorded distance. Preferably, the physical parameter of the receptacle is an internal height of the receptacle.

Preferably, when a change in the distance is detected, the controller records the displacement of the receptacle sensor. Preferably, a center of the receptacle is calculated based on the recorded displacement. Preferably, based on the calculated center of the receptacle, the outlet of the dispenser is positioned above the calculated center of the receptacle.

In a second aspect, the invention resides in a method of dispensing a consumable material into a receptacle, the method comprising:
moving a receptacle sensor relative to the receptacle by a motor operatively connected to the receptacle sensor, the receptacle sensor configured to emit a signal and receive a reflected signal from the receptacle;
determining, by a controller, a physical parameter of the receptacle based on the reflected signal and an operational parameter of the motor;
dispensing, by a dispenser, the consumable material into the receptacle based on the physical parameter.

Preferably, the method further comprises:
moving the receptacle sensor along a shaft connected to the motor; and
measuring a number of the revolutions or steps of the motor, the number of the revolutions or steps being the operational parameter of the motor.

Preferably, the method further comprises calculating a displacement of the receptacle sensor based on the operational parameter of the motor.

Preferably, the method further comprises:
comparing the reflected signal with a previous reflected signal;
determining a change in an intensity of the reflected signal to indicate that receptacle sensor has moved beyond an edge of the receptacle;
calculating the displacement of the receptacle sensor to determine a height of the receptacle, the height being the physical parameter of the receptacle.

Preferably, dispensing the consumable material comprises:
measuring, by a sensor of the dispenser, a level of the dispensed consumable material in the receptacle;
dispensing a quantity of the consumable material into the receptacle based on the level of the dispensed consumable material in the receptacle.

Preferably, determining the physical parameter of the receptacle
includes: moving the receptacle sensor along a shaft connected to the
motor; measuring a reflective value of the reflected signal;
determining, based on the reflective value, a distance from the surface from which the signal is reflected;
monitoring a change in the distance to sense an edge of the receptacle;
recording, by a controller, the distance when the change in the distance is sensed;
calculating, by the controller, the physical parameter of the receptacle based on the recorded distance.

Preferably, the method further comprises:
recording, by the controller, a displacement of the receptacle sensor when the change in the distance is sensed;
calculating, by the controller, a center of the receptacle based on the recorded displacement.

### BRIEF DESCRIPTION OF THE DRAWINGS

For a more complete understanding of the present invention, exemplary embodiments of the invention are explained in more detail in the following description with reference to the accompanying drawing figures, in which like reference signs designate like parts and in which:

FIG. 1 is a schematic system diagram of a system for dispensing a consumable material, according to an embodiment of the invention.

FIG. 2 is a schematic system diagram of a system for dispensing a consumable material, according to a further embodiment of the invention.

FIG. 3 is a schematic system diagram of a system for dispensing a consumable material, according to a further embodiment of the invention.

FIG. 4 illustrates a graph plotted based on the data/values measured and calculated during movement of the sensor carriage of the system shown in FIG. 3.

### DETAILED DESCRIPTION

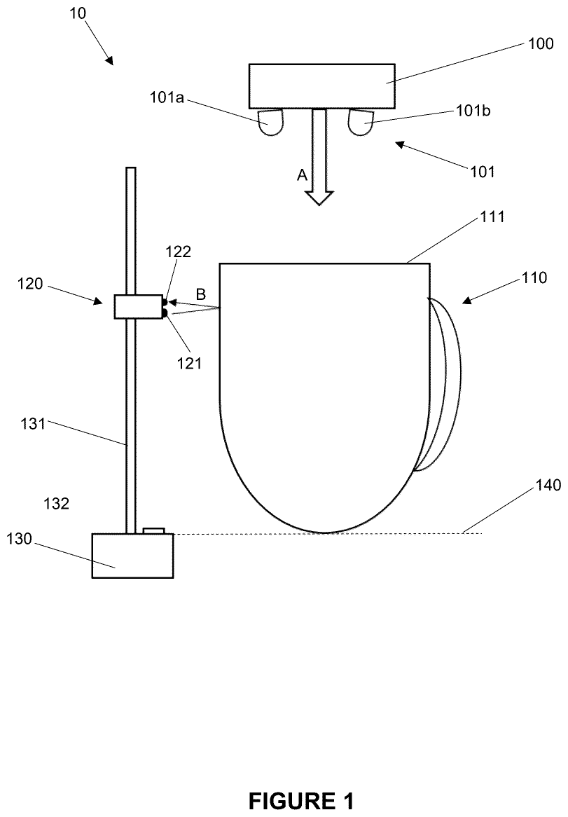

FIG. 1 illustrates a system 10 for dispensing a consumable material configured to allow a kitchen device to dispense a beverage or other consumable food material. In this embodiment, the system 10 is incorporated in a coffee machine (not shown), i.e. the coffee machine comprises the system 10 for dispensing coffee. However, in further embodiments, the system 10 may be incorporated in other kitchen devices, for example, juicer, water fountain/filter/dispenser, refrigerator, soup dispenser, soft drink dispenser etc. Moreover, in further embodiments, the system 10 may be configured to dispense other consumable food materials depending on the kitchen device it is installed in, for example, pulses, rice, spices, pasta etc and/or any other consumable fluids.

The system 10 includes a dispenser 100 to dispense the consumable material into a receptacle 110, a receptacle sensor 120 configured to emit and receive reflected signals, and a motor 130 operatively connected to the receptacle sensor 120 to move the receptacle sensor 120 relative to the receptacle 110. The dispenser 100 is located above the region where the receptacle 110 is to be placed and is spaced from the receptacle 110. The dispenser 100 comprises a nozzle or outlet (not shown) to dispense coffee into the receptacle 110 in the direction shown by arrow “A”. A sensor 101, in the form of an ultrasonic sensor, is located adjacent the outlet of the dispenser 100 and is configured to sense/determine a fluid level in the receptacle 110. The sensor 101 comprises a transmitter 101a that emits a signal and a receiver 101b that receives the reflected signal, the signal being reflected from the fluid in the receptacle 110 or a wall of the receptacle 110. However, in further embodiments, the sensor 101 may be a different type of sensor, for example, a time-of-flight (TOF) sensor, infrared sensor, LIDAR sensor etc. and/or the sensor may be located proximate the dispenser 100 or elsewhere on the kitchen device that allows the sensor 101 to sense a fluid level in the receptacle 110. Moreover, in further embodiments where the system 10 is incorporated in a kitchen device that dispenses a solid consumable material, the sensor 101 may be configured to sense a height of the dispensed consumable material in the receptacle 110.

The receptacle sensor 120 is connected to and travels along a shaft 131 in the form of a lead screw, the shaft 131 being connected to the motor 130 at an end thereof. The rotational movement of the motor 130 is converted to linear movement by the shaft 131 to move the receptacle sensor 120 along the shaft 131, i.e. the receptacle sensor 120 is movable up and down along the shaft 131 relative to the dispenser 100, the receptacle 110 and/or the motor 130. However, in further embodiments, the shaft 131 may be a linear actuator or any other transmission system to move the receptacle 120 along the shaft 131, for example, a rack and pinion arrangement.

The receptacle sensor 120 comprises a housing that is connected to the shaft 131, a transmitter 121 that emits a signal and a receiver 122 that receives the reflected signal, the signal being reflected from a wall of the receptacle 110 as shown by arrow “B”. In this embodiment, the receptacle sensor 120 is an infrared sensor. However, in further embodiments, the receptacle sensor 120 may be a different type of sensor, for example, an ultrasonic sensor, time-of-flight (TOF) sensor, LIDAR sensor etc.

The motor 130 is a stepper motor, although any other type of motor may be used that allows for movement of the receptacle sensor 120 along the shaft 131, for example, DC motor, AC motor, Brushless DC motor (BLDC) etc. The motor 130 is connected to one or more sensors that allow an operational parameter of the motor 130 to be determined while it is being used. In this embodiment, the motor 130 is connected to a Hall sensor (not shown) to count the number of revolutions/steps of the motor 130, which is then used to calculate displacement of the receptacle sensor 120 along the shaft 131, i.e. distance travelled by the receptacle sensor 120 along the shaft 131. The pitch of the thread of the shaft 131 and the number of revolutions/steps of the motor allow for the displacement of the receptacle sensor 120 to be calculated in real-time. However, in further embodiments, the displacement of the receptacle sensor 120 along the shaft 131 may be calculated by other means, for example, based on motor speed or speed of movement of the receptacle sensor 120 and the time taken for the receptacle sensor 120 to detect an edge of the receptacle 110 (as discussed below) using the formula ‘Speed=Distance/Time’.

In use, a user places the receptacle 110 on a receptacle base (not shown) of the coffee machine, in the form of a drip tray, the receptacle base having a weight sensor (not shown) which senses the receptacle 110 and issues a command to a controller (not shown) of the coffee machine to move the receptacle sensor 120 along the shaft 131 from its current position to locate a reference level 140. The reference level 140 is the level on which the bottom wall of the receptacle 110 rests and is sensed by the receptacle sensor 120 via a microswitch 132 located adjacent the reference level 140. However, in further embodiments, placing the receptacle 110 on the receptacle base would not automatically trigger the receptacle sensor 120 to locate the reference level 140, and the user would need to press one or more buttons (or equivalent touch interface key) and/or issue a voice command for the receptacle sensor 120 to locate the reference level 140. Moreover, in further embodiments, the receptacle sensor 120 may move to a “home position” after each brew cycle (i.e. after coffee has been brewed and dispensed), where the “home position” comprises the receptacle sensor 120 being aligned with the reference level 140, thereby eliminating the need for the receptacle sensor 120 to locate the reference level 140 after the receptacle 110 is placed on the receptacle base.

Next, the receptacle sensor 120 senses the receptacle 110 by emitting an infrared signal from the transmitter 121 and receiving the signal, by the receiver 122, after it has been reflected from a side wall of the receptacle 110, while the receptacle sensor 120 moves upwardly along the shaft 131 from the reference level 140. As the receptacle sensor 120 moves along the shaft 131, the displacement of the receptacle sensor 120 along the shaft 131 is calculated and noted by the controller, based on the number of revolutions/steps of the motor.

As the receptacle sensor 120 moves along the shaft 131, the controller compares a current signal received by the receiver 122 with the previous signal received by the receiver 122 to assess if there a change in the signal intensity or any other parameter of the signal. When the receptacle sensor 120 moves beyond an upper edge 111 of the receptacle 110, the signal emitted from the transmitter 121 is only partially reflected from the receptacle 110 and the sudden drop/decrease in the intensity of the reflected signal being received by the receiver 122 indicates to the controller that the receptacle sensor 120 has moved beyond an upper edge 111 of the receptacle 110. The displacement of the receptacle sensor 120 at this point, where the receptacle sensor 120 has moved beyond an upper edge 111 of the receptacle 110, is calculated and noted, by the controller, to be the height of the receptacle 110. In this manner, the controller is able to determine a physical parameter of the receptacle 110 based on the reflected signal and an operational parameter of the motor 130. However, in further embodiments, the controller may be configured to detect a different physical parameter of the receptacle 110 depending on the configuration and/or movement of the receptacle sensor 120, for example, width, curvature, shape etc. of the receptacle 110.

Once the height of the receptacle 110 has been calculated and noted, the dispenser 100 dispenses the consumable material, i.e. coffee, into the receptacle 110 based on the user preferences. The user preferences can be pre-set or entered by the user prior to the dispensing of the coffee and may include a quantity of the coffee to be dispensed (for example, one cup, half cup etc.), the type of coffee and/or the number of consumable materials (for example, coffee, milk, flavoured syrups etc.) or to be dispensed. As the coffee is being dispensed by the dispenser 100 into the receptacle 110, the sensor 101 that is located adjacent the outlet of the dispenser 100 measures the fluid level in the receptacle 110 and the quantity of coffee to be dispensed is controlled based on the measured fluid level and the calculated physical parameter of the receptacle 110 to ensure that the coffee is dispensed in accordance with the user preferences. For example, if the user preferences indicate that a half cup of coffee is required, the dispenser 100 dispenses coffee until a measured fluid level in the receptacle 110 is half the calculated height of the receptacle 110 and then automatically stops dispensing the coffee. In this manner, the dispenser 100 dispenses the consumable material into the receptacle 110 based on the physical parameter of the receptacle 110. In further embodiments where no quantity of the consumable material to be dispensed is specified by the user, the physical parameter of the receptacle 110 may be used to ensure that an appropriate quantity of coffee is dispensed, for example, ensuring that the receptacle is not overfilled or filled up to the upper edge 111.

In further embodiments, the receptacle base may be movable relative to the dispenser 100 such that, when the receptacle 110 is placed on the receptacle base, the receptacle base (with the receptacle 110 located thereon) is moved upwards until the upper edge 111 of the receptacle 110 engages with a detection sensor or a microswitch to identify the upper edge 111. The displacement of the receptacle base can then be used to ascertain the height of the receptacle 110 and the dispenser 100 can dispense coffee based on the height of the receptacle 110. Moreover, in further embodiments, instead of a detection sensor or a microswitch, a touch bar may be used that moves to a second position from a first position when it engages with the upper edge 111 of the receptacle 110 and, when the touch bar is in the second position, it is detected by a sensor, thereby indicating when the touch bar is engaged with upper edge 111 of the receptacle 110.

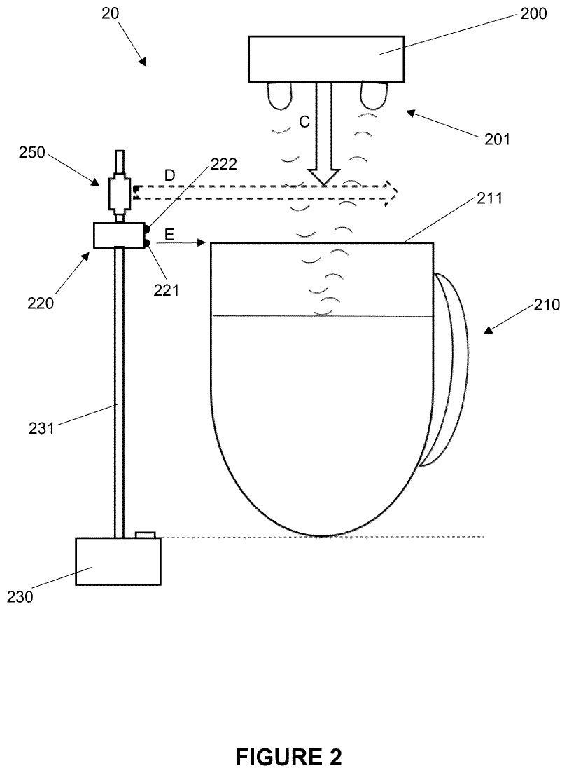

FIG. 2 illustrates a system 20 for dispensing a consumable material, according to a further embodiment of the invention. The system 20 is configured to allow a kitchen device to dispense a beverage or other consumable food material. The system 20 is similar to the system 10 but differences therebetween are noted below.

Like the system 10, the system 20 is incorporated in a coffee machine (not shown), i.e. the coffee machine comprises the system 20 for dispensing coffee and includes a dispenser 200 to dispense the consumable material into a receptacle 210 (in the direction shown by arrow “C”), a receptacle sensor 220 configured to emit and receive reflected signals, and a motor 230 operatively connected to the receptacle sensor 220 to move the receptacle sensor 220 relative to the receptacle 210. However, the system 20 further includes an anti-condensation module 250 located on the shaft 231 to prevent steam, generated from the hot coffee being dispensed, from condensing on the receptacle sensor 220 or the sensor 201 located adjacent the outlet (not shown) of the dispenser 200. In particular, the anti-condensation module 250 prevents condensation from being formed on the lens of the receptacle sensor 220 or the sensor 201. In further embodiments, the anti-condensation module 250 may be located elsewhere on the kitchen device, for example, in the body/housing of the coffee machine or adjacent the dispenser 200.

In this embodiment, the anti-condensation module 250 comprises an outlet (not shown) through which air is blown to displace/push the steam away from the receptacle sensor 220 and the sensor 201, in the direction shown by arrow “D”. However, in further embodiments, the outlet of the anti-condensation module 250 may provide a vacuum/suction effect to suck in the steam and/or the outlet may comprise a plurality of vents. Moreover, in further embodiments, an anti-condensation material or coating may be applied to the lens of the receptacle sensor 220 and/or the sensor 201 in addition to or instead of the anti-condensation module 250. The anti-condensation coating may be any food grade safe coating such as Luxere®, Glacial®, Brillianz® etc. that possesses anti-fog properties.

FIG. 2 also shows the receptable sensor 220 in a position along the shaft 231 where the receptable sensor 220 has detected the upper edge 211 of the receptacle 210. In particular, in the position shown in FIG. 2, the transmitter 221 of the receptable sensor 220 emits a signal in the direction shown by arrow “E” but only a portion of the signal is reflected and received by the receiver 222. The sudden drop/decrease in the intensity of the reflected signal being received by the receiver 222 indicates to the controller that the receptacle sensor 220 has moved beyond an upper edge 211 of the receptacle 210.

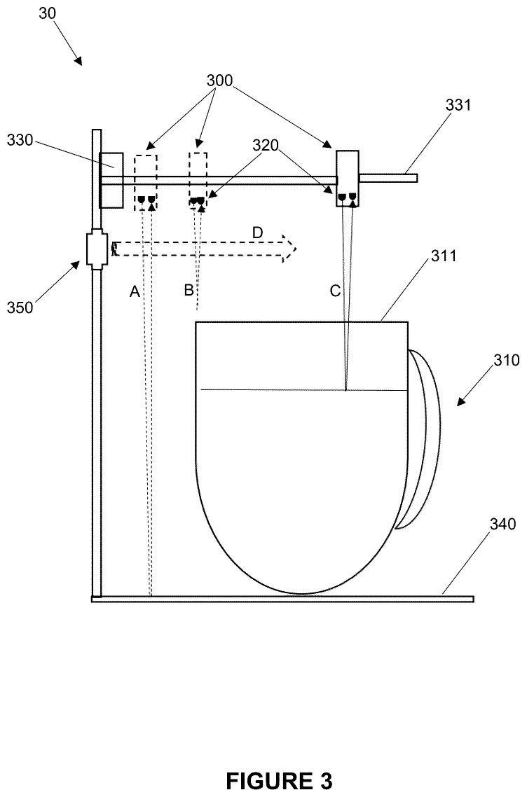

FIG. 3 illustrates a system 30 for dispensing a consumable material, according to a further embodiment of the invention. The system 30 is configured to allow a kitchen device to dispense a beverage or other consumable food material. In this embodiment, the system 30 is incorporated in a coffee machine (not shown), i.e. the coffee machine comprises the system 30 for dispensing coffee. However, in further embodiments, the system 30 may be incorporated in other kitchen devices, for example, juicer, water fountain/filter/dispenser, refrigerator, soup dispenser, soft drink dispenser etc. Moreover, in further embodiments, the system 30 may be configured to dispense other consumable food materials depending on the kitchen device it is installed in, for example, pulses, rice, spices, pasta etc and/or any other consumable fluids.

The system 30 includes a sensor carriage 300 that comprises a receptacle sensor 320 and a dispenser (not shown) to dispense the consumable material into a receptacle 310, and a motor 330 operatively connected to the sensor carriage 300 to move the sensor carriage 300 relative to the receptacle 310. As the receptacle sensor 320 is located in the sensor carriage 300, the receptacle sensor 320 also moves relative to the receptacle 310. The dispenser of the sensor carriage 300 comprises a nozzle or outlet (not shown) to dispense coffee into the receptacle 310, and the receptacle sensor 320 is configured to emit signals and receive reflected signals. The sensor carriage 300 travels along a shaft 331 in the form of a lead screw, the shaft 331 being connected to the motor 330 at an end thereof. However, in further embodiments, the shaft 331 may be a linear actuator or any other transmission system to move the sensor carriage 300 along the shaft 331, for example, a rack and pinion arrangement. Moreover, in further embodiments, the dispenser may be located in a separate housing that is distinct from the sensor carriage 300 and the housing containing the dispenser may move independently relative to the sensor carriage 300.

The receptacle sensor 320 comprises a transmitter that emits a signal and a receiver that receives the reflected signal, the signal being reflected from a receptacle base 340 as shown by arrow “A”, a wall of the receptacle 310 as shown by arrow “B” or fluid in the receptacle 310 as shown by arrow “C”. In this embodiment, the receptacle sensor 320 is an infrared sensor. However, in further embodiments, the receptacle sensor 320 may be a different type of sensor, for example, an ultrasonic sensor, time-of-flight (TOF) sensor, LIDAR sensor etc. Moreover, in further embodiments, the sensor carriage 300 may also comprise a further sensor, for example, an ultrasonic sensor, in addition to the receptacle sensor 320, to detect a fluid level in the receptacle 310.

The motor 330 is a stepper motor, although any other type of motor may be used that allows for movement of the sensor carriage 300 along the shaft 331, for example, DC motor, AC motor, Brushless DC motor (BLDC) etc. The motor 330 is connected to one or more sensors that allow an operational parameter of the motor 330 to be determined while it is being used. In this embodiment, the motor 330 is connected to a Hall sensor (not shown) to count the number of revolutions/steps of the motor 330, which is then used to calculate displacement of the sensor carriage 300 along the shaft 331, i.e. distance travelled by the sensor carriage 300 along the shaft 331. The pitch of the thread of the shaft 331 and the number of revolutions/steps of the motor allow for the displacement of the sensor carriage 300 to be calculated in real-time. However, in further embodiments, the displacement of the sensor carriage 300 along the shaft 331 may be calculated by other means, for example, based on motor speed or speed of movement of the sensor carriage 300 and the time taken for the receptacle sensor 320 in the sensor carriage 300 to detect an edge of the receptacle 310 (as discussed below) using the formula ‘Speed=Distance/Time’.

The system 30 further includes an anti-condensation module 350 to prevent steam generated from the hot coffee being dispensed from condensing on the receptacle sensor 320. In particular, the anti-condensation module 350 prevents condensation from being formed on the lens of the receptacle sensor 320. In this embodiment, the anti-condensation module 350 is located adjacent an end of the shaft 331 that is connected to the body of the coffee machine. However, in further embodiments, the anti-condensation module 350 may be located elsewhere on the kitchen device, for example, the anti-condensation module 350 may be located in a housing that travels along the shaft 331 or the anti-condensation module 350 may be incorporated into the sensor carriage 300.

In this embodiment, the anti-condensation module 350 comprises an outlet (not shown) through which air is blown to displace/push the steam away from the receptacle sensor 320, in the direction shown by arrow “D”. However, in further embodiments, the outlet of the anti-condensation module 350 may provide a vacuum/suction effect to suck in the steam and/or the outlet may comprise a plurality of vents. Moreover, in further embodiments, an anti-condensation material or coating may be applied to the lens of the receptacle sensor 320 in addition to or instead of the anti-condensation module 350. The anti-condensation coating may be any food grade safe coating such as Luxere®, Glacial®, Brillianz® etc. that possesses anti-fog properties.

In use, a user places the receptacle 310 on a receptacle base 340 of the coffee machine, in the form of a drip tray, and initiates the process to dispense coffee by pressing one or more buttons (or equivalent touch interface key) and/or issuing a voice command.

Upon initiating the dispensing process, the sensor carriage 300 moves to a “home position” which is an innermost proximal position of the sensor carriage 300, adjacent the motor 330. Next, the sensor carriage 300 begins to move along the shaft 331 toward a distal end of the shaft 331 and relevant data is recorded as the sensor carriage 300 moves (as discussed below).

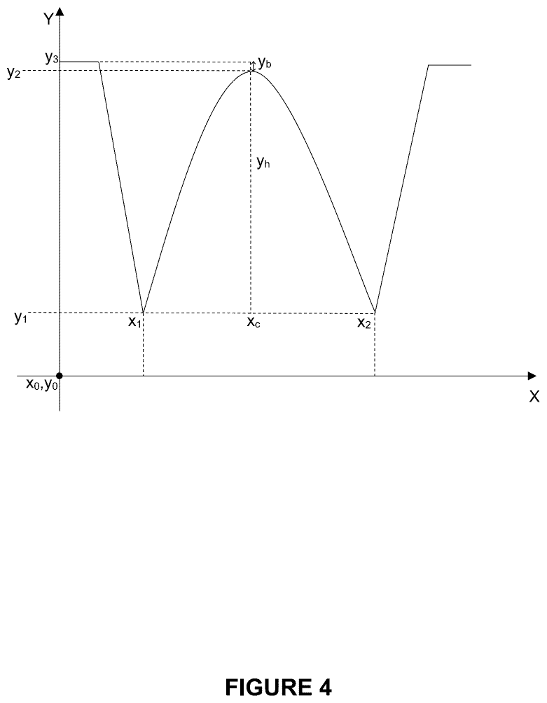

FIG. 4 illustrates a graph plotted based on the data/values measured and calculated while the sensor carriage 300 moves along the shaft 331. The “X” axis of the graph represents the distance travelled by the sensor carriage 300 and the “Y” axis of the graph represents emissivity based on a reflective value of the reflected signal. The height of or distance from the surface from which the reflected signal is received, by the receiver of the receptacle sensor 320, is determined by emissivity or reflectivity values of the reflected signal. As the presence of a receptacle 310 is initially detected, movement of the sensor carriage 300 is temporarily paused and a controller (not shown) of the system 30 records the distance travelled by the sensor carriage 300 (X₀) and a height relative to the receptacle base 340 (Y₃).

After recording the X₀ and Y₃ values, sensor carriage 300 continues to move along the shaft 331 while monitoring for any substantial changes in the height/distance measured by the receptacle sensor 320 and recording the minimum values of the height/distance based on the varying reflectivity values of the reflected signal. The minimum values of the height/distance would correspond to the edge 311 of the receptacle 310, i.e. the rim of the receptacle 310. When the edge 311 is first detected by the receptacle sensor 320, the height of the edge 311 is recorded (Y₁), along with the displacement of the sensor carriage 300 along the shaft 331 (X₁). The sensor carriage 300 continues to move along the shaft 331 while monitoring for a maximum value of the height/distance which would correspond to a bottom wall of the receptacle 310. When the bottom wall of the receptacle 310 is detected, by detecting a maximum value of the height/distance, the height of the bottom wall of the receptacle is recorded (Y₂). The sensor carriage 300 continues to move along the shaft 331 while monitoring for substantial changes in the height/distance measured by the receptacle sensor 320 to detect the edge 311 of the receptacle 310 again and, when the edge 311 is detected, the displacement of the sensor carriage 300 along the shaft 331 (X₂) is recorded. These recorded values allow the controller of the system 30 to determine various physical parameters of the receptacle 310 such as, a center of the receptacle 310 relative to its edge 311 or rim, a total height of the receptacle 310 relative to the receptacle base 340, a height of the bottom wall of the receptacle 310 relative to the receptacle base 340 and an internal height of the receptacle 310.

The center (X_{c}) of the receptacle 310 relative to its edge 311 or rim can be calculated based on the formula X_{c}=(X₂−X₁)/2. The sensor carriage 300 can then be moved along the shaft 331 such that the outlet of the dispenser of the sensor carriage 300 is positioned directly or substantially above the center of the receptacle 310.

The total height (Yₕ) of the receptacle 310 relative to the receptacle base 340 can be calculated based on the formula Yₕ=Y₂−Y₁, and the height (Y_{b}) of the bottom wall of the receptacle 310 relative to the receptacle base 340 (assuming the bottom wall is located at a height from the receptacle base 340) can be calculated based on the formula Y_{b}=Y₃−Y₂. With the Yₕ and Y_{b} values, the internal height (Y_{c}) of the receptacle 310 can be calculated based on the formula Y_{c}=Yₕ−Y_{b}. In this manner, the controller is able to determine a physical parameter of the receptacle 310 based on the reflected signal and an operational parameter of the motor 330.

Once the internal height of the receptacle 310 has been calculated, the dispenser of the sensor carriage 300 dispenses the consumable material, i.e. coffee, into the receptacle 310 based on the user preferences. The user preferences can be pre-set or entered by the user prior to the dispensing of the coffee and may include a quantity of the coffee to be dispensed (for example, one cup, half cup etc.), the type of coffee and/or the number of consumable materials (for example, coffee, milk, flavoured syrups etc.) or to be dispensed. As the coffee is being dispensed by the dispenser into the receptacle 310, the receptacle sensor 320 measures the fluid level in the receptacle 310 and the quantity of coffee to be dispensed is controlled based on the measured fluid level and the calculated physical parameter (i.e. the internal height) of the receptacle 310 to ensure that the coffee is dispensed in accordance with the user preferences. For example, if the user preferences indicate that a half cup of coffee is required, the dispenser dispenses coffee until a measured fluid level in the receptacle 310 is half the calculated internal height of the receptacle 310 and then automatically stops dispensing the coffee. In this manner, the dispenser dispenses the consumable material into the receptacle 310 based on the physical parameter of the receptacle 310. However, in further embodiments, the controller may calculate a volume of the receptacle 310 based on the data/values measured and calculated while the sensor carriage 300 moves along the shaft 331, and the calculated volume may be used to dispense a preferred quantity (1 cup, half cup etc.) of coffee relative to the volume of the receptacle 310. Moreover, in further embodiments where no quantity of the consumable material to be dispensed is specified by the user, the physical parameter of the receptacle 310 may be used to ensure that an appropriate quantity of coffee is dispensed, for example, ensuring that the receptacle is not overfilled or filled up to the upper edge 311.

The graph plotted based on the data/values measured and calculated while the sensor carriage 300 moves along the shaft 331 can also be used to determine if the receptacle 310 is partially filled or incorrectly placed on the receptacle base 340 (for example, in an inverted position). For example. When the receptacle 310 is located on the receptacle base 340 in an inverted position with the bottom wall of the receptacle 310 facing the receptacle sensor 320, the graph would indicate a flat peak. Such readings allow the controller to issue a notification or alarm to the user and to ensure that no coffee is dispensed until the receptacle 310 is appropriately placed on the receptacle base 340.

Various forms of the systems 10, 20, 30 described above may have one or more of the following advantages.

The systems 10, 20, 30 allow a user to input or select a preferred quantity of the consumable material to be dispensed, irrespective of the size of the receptacle 110, 210, 310, and the preferred quantity of the consumable material can be dispensed into the receptacle 110, 210, 310 without further input from the user, for example, pressing a button to stop the flow of the consumable material when the preferred quantity has been dispensed. Further, as the systems 10, 20, 30 can determine physical parameters of the receptacle 110, 210, 310, the recipe of the consumable material or beverage can be altered depending on the quantity of the beverage to be dispensed. The movable dispenser in the sensor carriage 300 of the system 30 allows for two or more receptacles 310 (of differing sizes) to be filled with a preferred quantity of the dispensed consumable material, by the same dispenser, without requiring any input from the user after the initial preferences have been input into the system 30.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

1. A system for dispensing a consumable material, the system comprising:
a dispenser to dispense the consumable material into a receptacle;
a receptacle sensor configured to emit a signal and receive a reflected signal from the receptacle, the receptacle sensor being movable relative to the receptacle;
a motor operatively connected to the receptacle sensor to move the receptacle sensor relative to the receptacle;
a controller configured to determine a physical parameter of the receptacle based on the reflected signal and an operational parameter of the motor;
wherein the dispenser dispenses the consumable material into the receptacle based on the physical parameter.

2. The system of claim 1, wherein a quantity of the consumable material dispensed by the dispenser is based on the physical parameter of the receptacle.

3. The system of claim 1, wherein the dispenser comprises a sensor to determine a level of the dispensed consumable material in the receptacle.

4. The system of claim 3, wherein the dispenser dispenses a quantity of the consumable material into the receptacle based on the level of the dispensed consumable material in the receptacle.

5. The system of claim 1, wherein the receptacle sensor moves along a shaft connected to the motor.

6. The system of claim 1, wherein the operational parameter of the motor is a number of the revolutions or steps of the motor.

7. The system of claim 1, wherein the physical parameter of the receptacle is a height of the receptacle.

8. The system of claim 1, wherein the receptacle sensor is an infrared, ultrasonic, time-of-flight or LIDAR sensor.

9. The system of claim 1, wherein the receptacle sensor and the dispenser are located in a sensor carriage that is movable relative to the receptacle.

10. The system of claim 1, wherein the system further includes an anti-condensation module configured to prevent condensation from being formed on the receptacle sensor.

11. The system of claim 10, wherein the anti-condensation module comprises an outlet through which air is blown or sucked.

12. (canceled)

13. The system of claim 1, wherein the controller is configured to determine a center of the receptacle based on the reflected signal.

14. (canceled)

15. A method of dispensing a consumable material into a receptacle, the method comprising:
moving a receptacle sensor relative to the receptacle by a motor operatively connected to the receptacle sensor, the receptacle sensor configured to emit a signal and receive a reflected signal from the receptacle;
determining, by a controller, a physical parameter of the receptacle based on the reflected signal and an operational parameter of the motor;
dispensing, by a dispenser, the consumable material into the receptacle based on the physical parameter.

16. The method of claim 15, wherein the method further comprises:
moving the receptacle sensor along a shaft connected to the motor; and measuring a number of the revolutions or steps of the motor, the number of the revolutions or steps being the operational parameter of the motor.

17. The method of claim 15, wherein the method further comprises calculating a displacement of the receptacle sensor based on the operational parameter of the motor.

18. The method of claim 17, wherein the method further comprises:
comparing the reflected signal with a previous reflected signal;
determining a change in an intensity of the reflected signal to indicate that receptacle sensor has moved beyond an edge of the receptacle;
calculating the displacement of the receptacle sensor to determine a height of the receptacle, the height being the physical parameter of the receptacle.

19. The method of claim 15, wherein dispensing the consumable material comprises:
measuring, by a sensor of the dispenser, a level of the dispensed consumable material in the receptacle;
dispensing a quantity of the consumable material into the receptacle based on the level of the dispensed consumable material in the receptacle.

20. The method of claim 15, wherein determining the physical parameter of the receptacle includes:
moving the receptacle sensor along a shaft connected to the motor; determining a reflective value of the reflected signal;
calculating, based on the reflective value, a distance from the surface from which the signal is reflected;
monitoring a change in the distance to sense an edge of the receptacle;
recording, by a controller, the distance when the change in the distance is sensed;
calculating, by the controller, the physical parameter of the receptacle based on the recorded distance.

21. The method of claim 20, wherein the method further comprises:
recording, by the controller, a displacement of the receptacle sensor when the change in the distance is sensed;
calculating, by the controller, a center of the receptacle based on the recorded displacement.

22. A computer-readable storage medium comprising instructions which, when executed by a controller, cause the controller to carry out the method of claim 15.
